(19) United States
(12) Patent Application Publication
(10) Pub. No.: US 2018/0201253 A1
(43) Pub. Date: Jul. 19, 2018

(54) VEHICLE CONTROL APPARATUS

(71) Applicant: TOYOTA JIDOSHA KABUSHIKI KAISHA, Toyota-shi (JP)

(72) Inventor: Kazuya FUJITA, Toyota-shi (JP)

(73) Assignee: TOYOTA JIDOSHA KABUSHIKI KAISHA, Toyota-shi (JP)

(21) Appl. No.: 15/858,657

(22) Filed: Dec. 29, 2017

(30) Foreign Application Priority Data
Jan. 18, 2017 (JP) 2017-007106

(51) Int. Cl. B60W 20/40; B60W 20/10; B60W 30/192

(52) U.S. Cl. CPC B60W 20/40; B60W 2510/0685; B60W 30/192; B60W 20/10

(57) ABSTRACT

A control apparatus for a vehicle with an engine, and an electric motor adjusting a torque to be transmitted to drive wheels, the control apparatus including: a control portion configured to control the electric motor to generate a drive-wheel-torque restricting torque for restricting a torque to be applied to the drive wheels upon initial explosion of the engine as a result of cranking of the engine to start the engine, when a predetermined length of delay time has passed after a point of time prior to a moment of the initial explosion of the engine. A time setting portion configured to set the predetermined length of delay time on the basis of an operating speed of the engine during cranking of the engine, and one of a pre-starting crank angle of the engine at rest and a rate of rise of the operating speed of the engine during its cranking.

This application claims priority from Japanese Patent Application No. 2017-007106 filed on Jan. 18, 2017, the disclosure of which is herein incorporated by reference in its entirety.

### FIELD OF THE INVENTION

The present invention relates to a control of a vehicle to reduce a shock upon first or initial explosion of its engine.

### BACKGROUND OF THE INVENTION

In the field of a vehicle provided with an engine and an electric motor, it has been proposed to control the electric motor so as to generate a drive-wheel-torque restricting torque for restricting a torque to be transmitted to drive wheels of the vehicle upon first or initial explosion of the engine as a result of cranking of the engine to start the engine. Patent Document 1 identified below discloses an example of a method of this control of the electric motor. This publication describes the generation of the drive-wheel-torque restricting torque by the electric motor at a point of time when a predetermined length of delay time has passed after a predetermined point of time prior to a moment of the initial explosion of the engine, namely, after a moment of generation of a command to start the engine (a moment of initiation of fuel injection and ignition control of the engine), and also describes setting of the length of delay time on the basis of a difference between a crank angle of the engine at rest and a target value of the crank angle in order to synchronize the moment of the initial explosion with the moment of the generation of the drive-wheel-torque restricting torque by the electric motor.

### PRIOR ART DOCUMENTS

Patent Document 1: JP-2009-161142A
Patent Document 2: JP-2008-155741A
Patent Document 3: JP-2009-184367A

### SUMMARY OF THE INVENTION

By the way, a rate of rise of an operating speed of the engine during its cranking varies depending upon the crank angle of the engine at rest, and the variation of the rate of rise of the engine speed results in a variation of the moment of the initial explosion of the engine. According to the method of control of the electric motor disclosed in Patent Document 1, the above-described length of delay time is set without taking account of the variation of the rate of rise of the engine speed, so that the moment of generation of the drive-wheel-torque restricting torque by the electric motor may not be accurately timed with the moment of the initial explosion of the engine, whereby the generated drive-wheel-torque restricting torque does not sufficiently achieve an intended effect.

The present invention was made in view of the background art described above. It is therefore an object of the present invention to provide a control apparatus for a vehicle, which permits effective reduction of a shock due to application of a torque to drive wheels of the vehicle upon initial explosion of an engine as a result of cranking of the engine.

The object indicated above is achieved according to the following modes of the present invention:

According to a first mode of the invention, there is provided a control apparatus for a vehicle provided with an engine as a drive power source, and an electric motor adjusting a torque to be transmitted to drive wheels, said control apparatus comprising: a control portion configured to control the electric motor so as to generate a drive-wheel-torque restricting torque for restricting a torque to be applied to the drive wheels upon initial explosion of the engine as a result of cranking of the engine to start the engine, when a predetermined length of delay time has passed after a predetermined point of time prior to a moment of the initial explosion of the engine; and a time setting portion configured to set the predetermined length of delay time on the basis of an operating speed of the engine during cranking of the engine, and one of a pre-starting crank angle of the engine at rest and a rate of rise of the operating speed of the engine during its cranking.

According to a second mode of the invention, the control apparatus according to the first mode of the invention is configured such that the above-indicated predetermined point of time is a moment of generation of a control command to initiate fuel injection into the engine, and the time setting portion sets the length of delay time on the basis of the operating speed of the engine at the moment of generation of the above-described control command and the pre-starting crank angle of the engine at rest.

According to a third mode of the invention, the control apparatus according to the first mode of the invention is configured such that the above-indicated predetermined point of time is a moment of generation of a control command to initiate fuel injection into the engine, or a point of time at which a predetermined time has passed after the moment of generation of the above-indicated control command, and the time setting portion sets the length of delay time on the basis of the operating speed of the engine at the moment of generation of the control command, and the rate of rise of the operating speed of the engine during a time period in the process of cranking of the engine, the time period starting from the moment of generation of the control command and having a length of the predetermined time.

According to the first mode of the invention, the length of delay time is set on the basis of the pre-starting crank angle of the engine at rest, or the rate of rise of the operating speed of the engine during its cranking. In this respect, it is noted that the rate of rise of the operating speed of the engine varies depending upon the pre-starting crank angle of the engine at rest, so that the length of delay time which is set on the basis of the pre-starting engine crank angle is determined with the rate of rise of the engine speed being taken into account. Accordingly, it is possible to reduce a time difference between the moment of the initial explosion of the engine and the moment of generation of the drive-wheel-torque restricting torque from the electric motor, which time difference is caused by the variation of the rate of rise of the engine speed. Therefore, it is possible to reduce the torque to be applied to the drive wheels upon the initial explosion of the engine, and it is accordingly possible to effectively reduce a shock to be given to the vehicle during the engine starting control.

According to the second mode of the invention, the pre-starting crank angle of the engine at rest is used to set the length of delay time. In this respect, it is noted that the rate of rise of the operating speed of the engine varies depending upon the pre-starting crank angle of the engine at rest, so that it is possible to reduce the time difference between the moment of the initial explosion of the engine and the moment of generation of the drive-wheel-torque restricting torque from the electric motor, without a need to calculate the rate of rise of the operating speed of the engine.

According to the third mode of the invention, the rate of change of the operating speed of the engine during cranking of the engine is used to set the length of delay time, so that it is possible to accurately synchronize the moment of generation of the drive-wheel-torque restricting torque from the electric motor, with the moment of the initial explosion of the engine.

### BRIEF DESCRIPTION OF THE DRAWINGS

FIG. 1 is a schematic view showing an arrangement of a hybrid vehicle to be controlled by a control apparatus in the form of an electronic control device according to a first embodiment of the present invention, and is also a block diagram illustrating major control portions of the control apparatus for controlling various portions of the hybrid vehicle;

FIG. 2 is a functional block diagram showing the major control portions of the electronic control device of FIG. 1;

FIG. 3 is a table indicating an example of a time setting map used by the electronic control device to set a length of delay time on the basis of an operating speed of an engine and a pre-starting crank angle of the engine;

FIG. 4 is a flow chart illustrating a major control operation of the electronic control device of FIG. 1, namely, an initial engine explosion compensation control routine executed to reduce a shock due to initial explosion of the engine during an engine starting control;

FIG. 5 is a time chart indicating changes of various parameters during execution of the initial engine explosion compensation control routine illustrated in the flow chart of FIG. 4;

FIG. 6 is a functional block diagram showing major control portions of an electronic control device according to a second embodiment of this invention for a hybrid vehicle;

FIG. 7 is a table indicating an example of a time setting map used by the electronic control device of FIG. 6 to set a length of delay time on the basis of the operating speed of the engine and a rise rate of the engine operating speed;

FIG. 8 is a flow chart illustrating a major control operation of the electronic control device of FIG. 6, namely, an initial engine explosion compensation control routine executed to reduce a shock due to initial explosion of the engine during an engine starting control;

FIG. 9 is a time chart indicating changes of various parameters during execution of the initial engine explosion compensation control routine illustrated in the flow chart of FIG. 8; and

FIG. 10 is a schematic view showing an arrangement of a power transmitting system of a hybrid vehicle different in construction from that of FIG. 1, which is controlled by a control apparatus according to the present invention.

### DETAILED DESCRIPTION OF PREFERRED EMBODIMENTS

Preferred embodiments of this invention will be described in detail by reference to the drawings. It is to be understood that the drawings showing the embodiments are simplified or transformed as needed, and do not accurately represent dimensions and shapes of various elements.

### First Embodiment

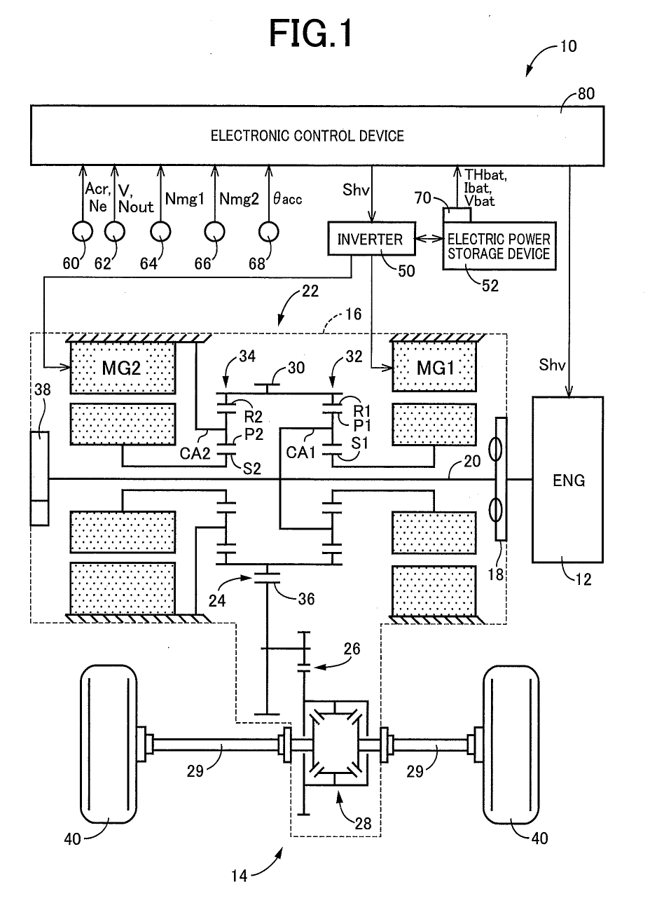

Reference is first made to FIG. 1, which is the schematic view showing an arrangement of a hybrid vehicle 10 (hereinafter referred to as “vehicle 10”) to be controlled by a control apparatus according to the present invention, and which is also the block diagram illustrating major control portions of the control apparatus for controlling various portions of the vehicle 10. As shown in FIG. 1, the vehicle 10 is provided with an engine 12 serving as a drive power source, and a transaxle (T/A) in the form of a power transmitting system 14. The power transmitting system 14 includes a damper 18, an input shaft 20, a transmission portion 22, a counter gear pair 24, a final gear pair 26, a differential gear device (final speed reduction gear) 28, and a pair of right and left axles (drive shafts) 29, which are disposed within a stationary member in the form of a casing 16 fixed to a body of the vehicle 10, in the order of description as seen from the side of the engine 12. The transmission portion 22 has: a first electric motor MG1; a power distributing mechanism 32 configured to distribute a drive force of the engine 12 to the first electric motor MG1 and an output gear 30; a gear mechanism 34 connected to the output gear 30; and a second electric motor MG2 operatively connected to the output gear 30 through the gear mechanism 34 in a power transmittable manner. The output gear 30 is an output rotary member of the transmission portion 22 (power distributing mechanism 32). The counter gear pair 24 consists of the output gear 30 and a counter driven gear 36. The input shaft 20 is connected at its one end to the engine 12 through the damper 18, so that the input shaft 20 is rotated by the engine 12. An oil pump 38 is connected to the other end of the input shaft 20, and is operated with a rotary motion of the input shaft 20, so that a lubricant is delivered from the oil pump 38 to various parts of the power transmitting system 14, such as the power distributing mechanism 32, gear mechanism 34 and ball bearings not shown. In the power transmitting system 14 constructed as described above, a drive force of the engine 12 received through the damper 18 and the input shaft 20, and a drive force of the second electric motor MG2 are transmitted to the output gear 30, and are transmitted from the output gear 30 to a pair of drive wheels 40 through the counter gear pair 24, final gear pair 26, differential gear device 28, and pair of axles (drive shafts) 29, in the order of description. The first electric motor MG1 corresponds to an electric motor of the vehicle 10 to be controlled by the control apparatus according to the invention.

The power distributing mechanism 32 is a known planetary gear set of a single-pinion type having rotary elements (rotary members) consisting of a first sun gear S1, a first carrier CA1 and a first ring gear R1. The first carrier CA1 supports a first pinion gear P1 such that the first pinion gear P1 is rotatable about its axis and about an axis of the planetary gear set. The first ring gear R1 meshes with the first sun gear S1 through the first pinion gear P1. The power distributing mechanism 32 functions as a differential mechanism operable to perform a differential operation. In this power distributing mechanism 32, the first carrier CA1 serving as a first rotary element RE1 is connected to the input shaft 20, namely, to the engine 12, and the first sun gear S1 serving as a second rotary element RE2 is connected to the first electric motor MG1, while the first ring gear R1 serving as a third rotary element RE3 is connected to the output gear 30. In the transmission portion 22 wherein the first sun gear S1, first carrier CA1 and first ring gear R1 are rotatable relative to each other, an output of the engine 12 is distributed to the first electric motor MG1 and the output gear 30, and the first electric motor MG1 is operated with the drive force of the engine 12 distributed to the first electric motor MG1 to generate an electric energy. The electric energy generated by the first electric motor MG1 is stored in an electric power storage device 52 through an inverter 50, and the second electric motor MG2 is operated with the electric energy generated by the first electric motor MG1. Accordingly, the transmission portion 22 is placed, for example, in a continuously variable shifting state (electric CVT state) in which the transmission portion 22 functions as an electrically controlled continuously variable transmission a speed ratio γ0 of which is continuously variable. The speed ratio γ0 is equal to a ratio of an operating speed Ne of the engine 12 (hereinafter referred to as “engine speed Ne”) with respect to an output speed Nout of the transmission portion 22 (rotating speed Nout of the output gear 30). Namely, the transmission portion 22 functions as an electrically controlled differential portion (electrically controlled continuously variable transmission) in which a differential state of the power distributing mechanism 32 is controllable by controlling an operating state of the first electric motor MG1 which functions as a differential-state controlling electric motor. Thus, the transmission portion 22 permits the engine 12 to be operated at an operating point at which its fuel economy is highest, that is, at a highest fuel economy point. For instance, the operating point of the engine 12 (“engine operating point”) is represented by the engine speed Ne and a torque Te of the engine 12 (hereinafter referred to as “engine torque Te”). This type of hybrid drive system is called a mechanical distribution type or split type.

The gear mechanism 34 is a known planetary gear set of a single-pinion type having rotary elements consisting of a second sun gear S2, a second carrier CA2 and a second ring gear R2. The second carrier CA2 supports a second pinion gear P2 such that the second pinion gear P2 is rotatable about its axis and about an axis of the planetary gear set. The second ring gear R2 meshes with the second sun gear S2 through the second pinion gear P2. In the gear mechanism 34, the second carrier CA2 is fixed to the stationary member in the form of the casing 16, and is thus held stationary, and the second sun gear S2 is connected to the second electric motor MG2, while the second ring gear R2 is connected to the output gear 30. The planetary gear set of the gear mechanism 34 has a gear ratio (=number of teeth of the sun gear S2/number of teeth of the ring gear R2) which is determined so that the gear mechanism 34 functions as a speed reducing device. When the second electric motor MG2 generates a vehicle driving torque, a rotary motion of the second electric motor MG2 is transmitted to the output gear 30 such that a rotating speed of the output gear 30 is reduced with respect to an output speed of the second electric motor MG2, and thus a torque received by the output gear 30 is increased with respect to an output torque of the second electric motor MG2. The output gear 30 is a composite gear having not only functions of the ring gear R1 of the power distributing mechanism 32 and the ring gear R2 of the gear mechanism 34, but also a function of a counter drive gear which meshes with the counter driven gear 36 and cooperates with the counter driven gear 36 to constitute the counter gear pair 24.

For instance, each of the first and second electric motors MG1 and MG2 is a synchronous electric motor having at least one of a function of an electric motor operable to convert an electric energy into a mechanical drive force, and a function of an electric generator operable to convert a mechanical drive force into an electric energy. Preferably, each electric motor MG1, MG2 is a motor/generator which is operated selectively as an electric motor or an electric generator. For example, the first electric motor MG1 has a function of an electric generator operable to generate a regenerative torque counteracting the engine torque Te, and a function of an electric motor operable to start the engine 12 which has been held at rest. On the other hand, the second electric motor MG2 has a function of a vehicle driving electric motor serving as a vehicle drive power source operable to generate a vehicle drive force, and a function of an electric generator operable with a reverse drive force received from the drive wheels 40, to generate an electric energy while generating a regenerative torque.

The vehicle 10 is provided with the control apparatus in the form of an electronic control device 80 configured to control various devices of the vehicle 10. For example, the electronic control device 80 includes a so-called microcomputer incorporating a CPU, a ROM, a RAM and an input-output interface. The CPU performs control operations of the vehicle 10, by processing various signals according to control programs stored in the ROM, while utilizing a temporary data storage function of the RAM. For instance, the control operations performed by the electronic control device 80 include hybrid drive controls of the engine 12, first electric motor MG1 and second electric motor MG2. The electronic control device 80 may be constituted by two or more control units exclusively assigned to perform different control operations such as output controls of the engine 12 and output controls of the first and second electric motors MG1 and MG2. The electronic control device 80 receives various input signals such as: an output signal of a speed sensor 60 indicative of a crank angle Acr and the operating speed Ne of the engine 12; an output signal of a speed sensor 62 indicative of the rotating speed Nout of the output gear 30 corresponding to a running speed V of the vehicle 10; an output signal of a speed sensor 64 indicative of an operating speed Nmg1 of the first electric motor MG1 (hereinafter referred to as “MG1 speed Nmg1”); an output signal of a speed sensor 66 indicative of an operating speed Nmg2 of the second electric motor MG2; an output signal of an accelerator pedal operation amount sensor 68 indicative of an operation amount θacc of an accelerator pedal; an output signal of a battery sensor 70 indicative of a temperature THbat, a charging/discharging electric current Ibat and a voltage Vbat of the electric power storage device 52. These sensors 60 to 70 are provided in the vehicle 10. Further, the electronic control device 80 generates various output signals for controlling various devices of the vehicle 10, such as hybrid control command signals Shv including engine control command signals to be applied to the engine 12, and electric motor control command signals (shifting control command signals) to be applied to the inverter 50. The electronic control device 80 calculates from time to time a charging state (stored electric power amount) SOC of the electric power storage device 52 on the basis of its temperature THbat, charging/discharging electric current Ibat and voltage Vbat.

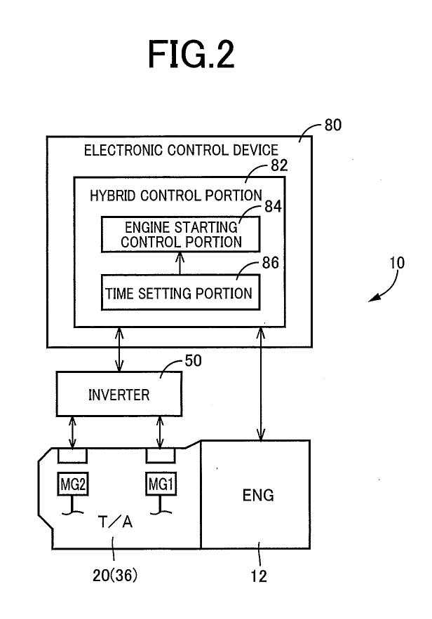

FIG. 2 is the functional block diagram showing the major control portions of the electronic control device 80. As shown in FIG. 2, the electronic control device 80 includes hybrid control means, that is, a hybrid control portion 82.

For example, the hybrid control portion 82 is configured to calculate a required vehicle drive torque Touttgt as a required drive force (an operator-required drive force) of the vehicle 10 by a driver on the basis of the accelerator pedal operation amount θacc and the vehicle running speed V. Then, the hybrid control portion 82 generates the hybrid control command signals Shy for controlling the drive power source (engine 12 and second electric motor MG2) so as to obtain the calculated required vehicle drive torque Touttgt, while taking account of a required value of charging of the electric power storage device 52.

The hybrid control portion 82 selectively establishes one of predetermined vehicle drive modes, according to a running state of the vehicle 10. The predetermined vehicle drive modes include: a motor drive mode (EV drive mode) in which only the second electric motor MG2 is operated as the drive power source while the engine 12 is held at rest; an engine drive mode (steady-state drive mode) in which at least the engine 12 is operated as the drive power source such that the engine torque Te is directly transmitted to the output gear 30 (drive wheels 40), while the first electric motor MG1 generates a regenerative torque counteracting the engine torque Te, and such that the second electric motor MG2 is operated as needed, with an electric power generated by the first electric motor MG1, so that an output torque of the second electric motor MG2 is transmitted to the output gear 30; and an engine-assisting drive mode (vehicle accelerating drive mode) in which the second electric motor MG2 is operated with the electric energy stored in the electric power storage device 52, to generate an assisting drive torque to be added to the engine torque Te. The above-indicated required vehicle drive force may be other than the required vehicle drive torque Touttgt [Nm] to be transmitted to the drive wheels 40, for instance, a required drive force [N] to be transmitted to the drive wheels 40, a required drive power [W] to be transmitted to the drive wheels 40, a required output torque to be transmitted to the output gear 30, or a target output torque of the drive power source. Alternatively, the required vehicle drive force may be simply represented by the accelerator pedal operation amount θacc [%], an opening angle [%] of a throttle valve, or an intake air quantity [g/sec] of the engine 12.

The hybrid control portion 82 establishes the motor drive mode when the running state of the vehicle 10 represented by an actual value of the vehicle running speed V and the required vehicle drive force (accelerator pedal operation amount θacc or required vehicle drive torque Touttgt) falls within a predetermined motor drive region which is obtained by experimentation or calculation and stored in a memory. On the other hand, the hybrid control portion 82 establishes the engine drive mode or the engine-assisting drive mode when the vehicle running state falls within a predetermined engine drive region. The motor drive region indicated above is a region in which the required vehicle drive force is smaller than in the engine drive region. The hybrid control portion 82 is further configured to drive the vehicle 10 with an operation of the engine 12, even when the vehicle running state falls within the motor drive region, in the following cases: where the vehicle 10 cannot be driven in the motor drive mode due to limitation of discharging of the electric power storage device 52, which limitation is determined on the basis of the electric power amount SOC stored in the electric power storage device 52, and/or a maximum amount Wout of discharging of electric power from the electric power storage device 52 determined according to its temperature THbat; where the electric power storage device 52 is required to be charged; and where the engine 12 or any device associated with the engine 12 is required to be warmed up.

The hybrid control portion 82 includes an engine starting control means or engine starting control portion 84 configured to start the engine 12 when the engine 12 is required to be started during running of the vehicle 10 in the motor drive mode, as a result of a rise of the vehicle running speed V, an increase of the required vehicle drive force, shortage of the electric power amount SOC stored in the electric power storage device 52, or requirement for warming up the engine 12, for example. During running of the vehicle 10 in the motor drive mode, the engine starting control portion 84 makes a determination as to whether the engine 12 is required to be started, on the basis of the rise of the vehicle running speed V, the increase of the required vehicle drive force, the shortage of the electric power amount SOC, or the requirement for warming up the engine 12. When the determination is made that the engine 12 is required to be started, the engine starting control portion 84 implements an engine starting control in which the engine 12 is cranked with a drive force of the first electric motor MG1, to raise its operating speed Ne, so that the engine 12 is started. Namely, the engine starting control portion 84 commands the first electric motor MG1 to generate an output torque (hereinafter referred to as “MG1 torque Tmg1”) as an engine cranking torque for raising the engine speed Ne with a rise of the MG1 speed Nmg1. When a predetermined length of time has passed after a moment of the determination of requirement for starting the engine 12, that is, when the engine speed Ne has been raised to a predetermined value above which the engine 12 can be operated by itself, the engine starting control portion 84 initiates fuel injection into the engine 12 and ignition of the engine 12, to start the engine 12. It is noted that the engine starting control portion 84 corresponds to a control portion of the control apparatus according to the present invention.

Upon initial explosion of the engine 12 in the process of the engine starting control, namely, during cranking of the engine 12, a torque is generated by the engine 12 as a result of its initial explosion, and is applied to the drive wheels 40 through the damper 18, so that the vehicle 10 is undesirably given a shock. Further, the damper 18 is subjected to a torsional stress and twisted due to the torque generated upon the initial explosion of the engine 12, so that there arises a risk of mutual butting of gears disposed in a power transmitting path between the engine 12 and the drive wheels 40, and consequent generation of tooth butting noises of the gears, when the twisted damper 18 is restored to its original state. To reduce this risk, the engine starting control portion 84 implements an initial engine explosion compensation control to control the first electric motor MG1 so as to generate a torque (hereinafter referred to as “drive-wheel-torque restricting torque Tcon) for restricting the torque to be applied to the drive wheels 40 (output gear 30), in synchronization with the initial explosion of the engine 12. Described more specifically, the engine starting control portion 84 controls the first electric motor MG1 so as to generate a sum Tsum (=Tmg1+Tcon) of the MG1 torque Tmg1 according to the engine starting control and the above-indicated drive-wheel-torque restricting torque Tcon (also called “compensation torque”) determined to restrict the torque to be applied to the drive wheels 40 upon the initial explosion of the engine 12, when a predetermined length of delay time (waiting time) tset1 has passed after a predetermined point of time prior to a moment of the initial explosion of the engine 12 during its cranking, for example, after a moment of generation of a control command to initiate the fuel injection into the engine 12 (hereinafter referred to as “fuel injection command”), namely, after a moment at which a fuel cut flag is turned from an ON state to an OFF state. A direction and a magnitude of the drive-wheel-torque restricting torque Tcon are determined by experimentation or calculation, such that the drive-wheel-torque restricting torque Tcon counteracts the torque to be applied to the drive wheels 40 upon the initial explosion of the engine 12. Further, the length of delay time tset1 is set such that the initial explosion of the engine 12 takes place when the set length of delay time tset1 has passed after the moment of generation of the fuel injection command. That is, the length of delay time tset1 is determined such that the generation of the drive-wheel-torque restricting torque Tcon from the first electric motor MG1 takes place in synchronization with the initial explosion of the engine 12. The manner of setting of the length of delay time tset1 will be further described.

According to the initial engine explosion compensation control implemented by the engine starting control portion 84, the torque to be applied to the drive wheels 40 upon the initial explosion of the engine 12 is restricted or reduced owing to the generation of the sum Tsum of the MG1 torque Tmg1 and the drive-wheel-torque restricting torque Tcon from the first electric motor MG1, so that the generation of the shock during the engine starting control is effectively reduced. Further, the drive-wheel-torque restricting torque Tcon is a positive torque (driving torque) acting to reduce the torsional stress given to the damper 18 upon the initial explosion of the engine 12, that is, to raise a rotating speed of an output member of the damper 18 on the side of the drive wheels 40, so that the torsional stress given to the damper 18 is reduced. Accordingly, it is possible to reduce the risk of mutual butting of the gears disposed in the power transmitting path between the engine 12 and the drive wheels 40, and the consequent generation of the tooth butting noises of the gears, when the twisted damper 18 is restored to its original state.

The hybrid control portion 82 further includes a time setting means or time setting portion 86 configured to set the length of delay time tset1 from the moment of generation of the fuel injection command to the engine 12 to the moment of generation of the drive-wheel-torque restricting torque Tcon. The length of delay time tset1 is set by experimentation or calculation, such that the initial explosion of the engine 12 takes place when the set length of delay time tset1 has passed after the moment of generation of the fuel injection command, namely, such that the drive-wheel-torque restricting torque Tcon is generated upon the initial explosion of the engine 12. It is noted that the time setting portion 86 corresponds to a time setting portion of the control apparatus according to the present invention.

For example, the length of time from the moment of generation of the fuel injection command to the moment of the initial explosion of the engine 12 decreases with a rise of the engine speed Ne at the moment of generation of the fuel injection command, and with an increase of a rate of rise ΔNe of the engine speed Ne in the process of the engine starting control (during cranking of the engine 12). It is known that the rate of rise ΔNe of the engine speed Ne varies according to a crank angle Acr of the engine 12 at rest (prior to its starting), that is, a pre-starting crank angle Acr of the engine 12 at rest. In view of these facts, the time setting portion 86 sets the length of delay time tset1 on the basis of the engine speed Ne at the moment of generation of the fuel injection command during cranking of the engine 12, and the pre-starting crank angle Acr of the engine 12 at rest. The time setting portion 86 stores therein a time setting map (described below in detail) used for setting the length of delay time tset1 on the basis of the engine speed Ne at the moment of generation of the fuel injection command and the pre-starting crank angle Acr of the engine 12 at rest. The time setting portion 86 is configured to read in an actual value Acrx of the pre-starting crank angle Acr of the engine 12 at rest, and an actual value Nex of the engine speed Ne at the moment of generation of the fuel injection command, and to set the length of delay time tset1 according to the time setting map. The engine starting control portion 84 implements the engine starting control on the basis of the set length of delay time tset1, so as to reduce a time difference between the moment of the initial explosion of the engine 12 and the moment of generation of the drive-wheel-torque restricting torque Tcon. Namely, the engine starting control portion 84 is configured to set the length of delay time tset1 while taking account of not only the engine speed Ne but also the pre-starting crank angle Acr of the engine 12 (that is, the rate of rise ΔNe of the engine speed Ne), so that the generation of the drive-wheel-torque restricting torque Tcon from the first electric motor MG1 is accurately synchronized with the initial explosion of the engine 12.

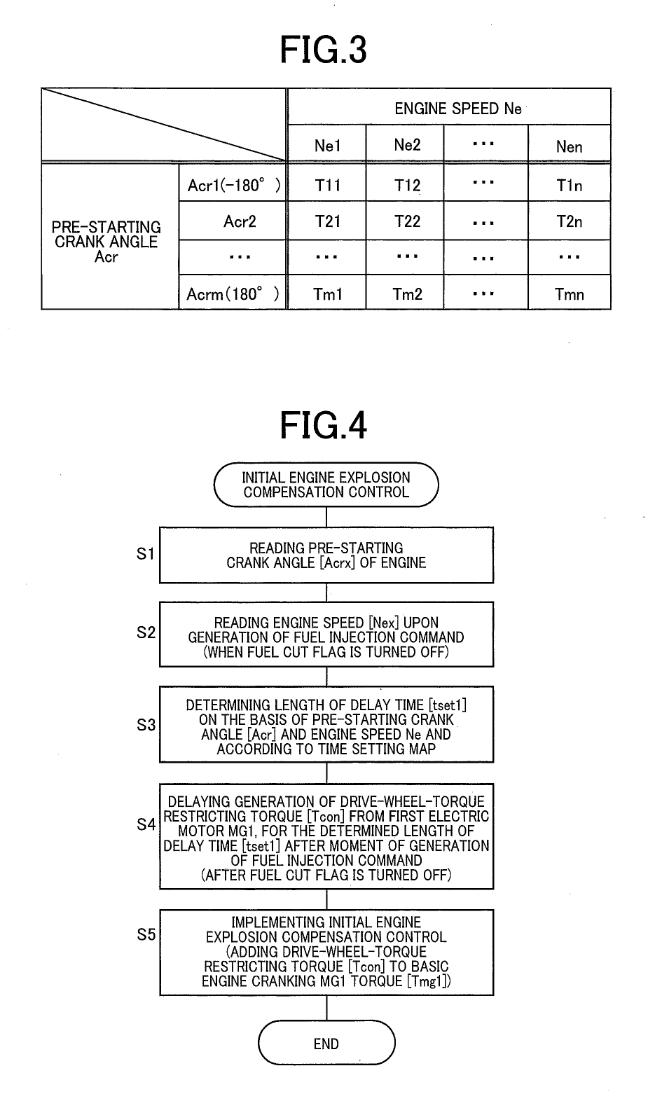

FIG. 3 is the table indicating an example of the time setting map used by the time setting portion 86 to set the length of delay time (waiting time) tset1 on the basis of the engine speed Ne and the pre-starting crank angle Acr of the engine 12 at rest. This time setting map is obtained by experimentation or calculation. As shown in FIG. 3, the time setting map is defined in a two-dimensional coordinate system in which the pre-starting crank angle Acr and the engine speed Ne are taken in the respective two axes. In the time setting map, the engine speed Ne is defined in a range between Ne1 and Nen in which the engine speed Ne is estimated to fall at the moment of generation of the fuel injection command. The pre-starting crank angle Acr of the engine 12 is defined in a range between −180° and +180°, where the center crank angle Acr is 0° when a piston of the engine 12 is located at its top dead center. Namely, in the time setting map of FIG. 3, the crank angle Acr1 is −180° while the crank angle Acrm is +180°.

The time setting map of FIG. 3 is formulated such that the length of delay time tset1 decreases with a rise of the engine speed Ne, and such that the length of delay time tset1 at a given value of the engine speed Ne at the moment of generation of the fuel injection command varies according to the pre-starting crank angle Acr of the engine 12. Described more specifically, the length of delay time tset1 decreases as the pre-starting crank angle Acr changes with an increase of the rate of rise ΔNe of the engine speed Ne during cranking of the engine 12. In this respect, it is noted that the rate of rise ΔNe of the engine speed Ne during cranking of the engine 12 according to the pre-starting crank angle Acr of the engine 12 varies depending upon the type and the number of cylinders of the engine 12, so that the rate of rise ΔNe is obtained by experimentation or calculation for the specific configuration of the engine 12. It is noted that the length of delay time tset1 need not be obtained according to the time setting map as shown in FIG. 3, but may be obtained on the basis of an actual value Nex of the engine speed Ne and an actual value Acrx of the pre-starting crank angle Acr of the engine 12, and according to a predetermined equation which includes, as variable, the engine speed Ne and the pre-starting engine crank angle Acr.

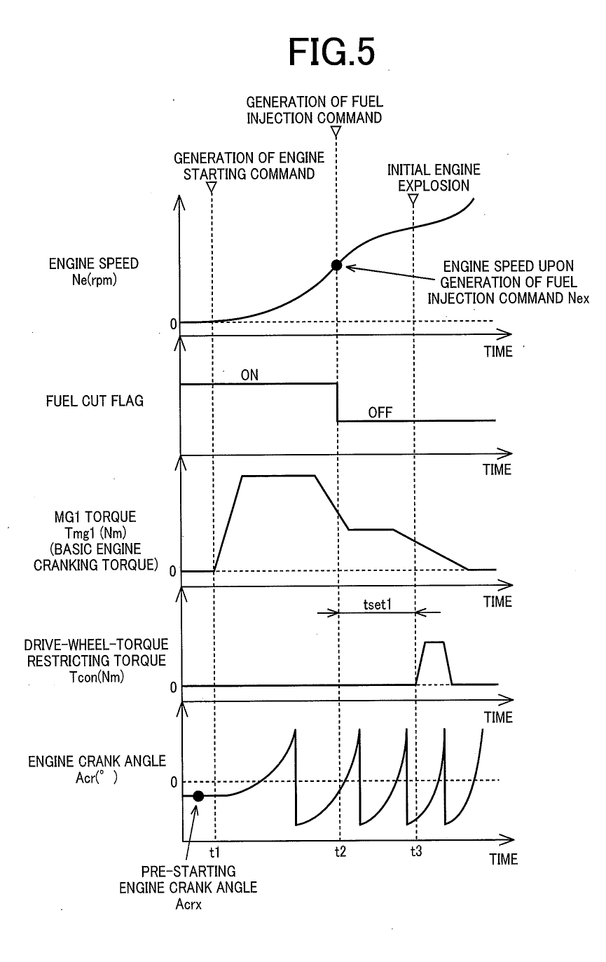

FIG. 4 is the flow chart illustrating a major control operation of the electronic control device 80, namely, an initial engine explosion compensation control routine executed to reduce the shock to be given to the vehicle 10 and the tooth butting noise due to the initial explosion of the engine 12 during the engine starting control (during cranking of the engine 12). This initial engine explosion compensation control routine is executed concurrently with the engine starting control initiated upon determination of requirement for starting the engine 12.

The control routine of FIG. 4 is initiated with a step S1 corresponding to the function of the time setting portion 86, to read the pre-starting crank angle Acrx of the engine 12. Then, the control flow goes to a step S2 also corresponding to the function of the time setting portion 86, to read the engine speed Nex at the moment of generation of the fuel injection command to the engine 12 (at the moment at which the fuel cut flag is turned off). The control flow then goes to a step S3 also corresponding to the function of the time setting portion 86, to set or determine the length of delay time tset1 on the basis of the actual crank angle value Acrx and the actual engine speed value Nex read in the respective steps S1 and S2, and according to the time setting map. Then, the control flow goes to a step S4 corresponding to the function of the engine starting control portion 84, to delay the generation of the drive-wheel-torque restricting torque Tcon from the first electric motor MG1, for the length of delay time tset1 set in the step S3, after the moment of generation of the fuel injection command (after the fuel cut flag is turned off). The control flow then goes to a step S5 also corresponding to the function of the engine starting control portion 84, to implement the initial engine explosion compensation control when the length of delay time tset1 has passed after the moment of generation of the fuel injection command. In the initial engine explosion compensation control, the first electric motor MG1 is controlled to generate the sum Tsum of the MG1 torque Tmg1 to crank the engine 12 (which changes according to a basic pattern of engine cranking torque), and the drive-wheel-torque restricting torque Tcon.

FIG. 5 is the time chart indicating changes of various parameters during the engine starting control (i.e. during execution of cranking of the engine) while the initial engine explosion compensation control routine illustrated in the flow chart of FIG. 4 is executed to reduce the risk of generation of the shock to be given to the vehicle 10 and generation of the tooth butting noises of the gears due to the initial explosion of the engine 12. In the time chart of FIG. 5, the time t(sec) is taken along the horizontal axis while the engine speed Ne, the fuel cut flag, the MG1 torque Tmg1, the drive-wheel-torque restricting torque Tcon and the engine crank angle Acr are taken along the vertical axis.

Prior to a point of time t1, the fuel cut flag is held in the ON state so that a supply of a fuel to the engine 12 is cut, and the engine speed Ne is held at zero (the engine 12 is held at rest). At the point of time t1, a command to start the engine 12 is generated, and a rise of the torque Tmg1 of the first electric motor MG1 along the predetermined pattern of basic engine cranking torque shown in FIG. 5 is initiated, so that the engine speed Ne is raised. The basic pattern of engine cranking value of the MG1 torque Tmg1 is predetermined so as to crank the engine 12 (to raise the engine speed Ne). At the point of time t1 at which the engine starting command is generated, the pre-starting engine crank angle Acrcx is read.

At a point of time t2, the fuel injection command is generated, namely, the fuel cut flag is turned from the ON state to the OFF state, and the engine speed Nex at the point of time t2 is read. Further, the length of delay time tset1 is set on the basis of the pre-starting engine crank angle Acrx and the engine speed Nex, so that the generation of the drive-wheel-torque restricting torque Tcon is delayed for the set length of delay time tset1 after the point of time t2 at which the fuel injection command is generated. At a point of time t3 at which the length of delay time tset1 has passed after the point of time t2, the first electric motor MG1 is controlled so as to generate the drive-wheel-torque restricting torque Tcon. Described more specifically, the first electric motor MG1 is controlled so as to generate the sum Tsum of the MG1 torque Tmg1 and the drive-wheel-torque restricting torque Tcon. Since the length of delay time tset1 is set on the basis of the engine speed Ne, and the pre-starting engine crank angle Acr upon which the rate of rise ΔNe of the engine speed Ne varies, the drive-wheel-torque restricting torque Tcon is generated at the moment of the initial explosion of the engine 12, with the variation of the rate of rise ΔNe being taken into account, so that the risk of generation of a shock to be given to the vehicle 10 due to the torque applied to the drive wheels 40 upon the initial explosion of the engine 12 can be effectively reduced, whereby the risk of generation of the tooth butting noises of the gears due to the torsional stress applied to the damper 18 upon the initial engine explosion can be effectively reduced.

As described above, the present embodiment is configured to set the length of delay time tset1 on the basis of the engine speed Ne, and the pre-starting crank angle Acr of the engine 12 at rest. The rate of rise ΔNe of the engine speed Ne varies depending upon the pre-starting crank angle Acr of the engine 12 at rest, so that the length of delay time tset1 which is set on the basis of the pre-starting engine crank angle Acr is determined with the rate of rise ΔNe of the engine speed Ne being taken into account. Accordingly, it is possible to reduce a time difference between the moment of the initial explosion of the engine 12 and the moment of generation of the drive-wheel-torque restricting torque Tcon from the first electric motor MG1, which time difference is caused by the variation of the rate of rise ΔNe of the engine speed Ne. Therefore, it is possible to accurately restrict the torque to be applied to the drive wheels 40 upon the initial explosion of the engine 12, and it is accordingly possible to effectively reduce the shock to be given to the vehicle 10 during the engine starting control. Further, the present embodiment does not need an operation to calculate the rate of rise ΔNe of the engine speed Ne, since the rate of rise ΔNe is estimated on the basis of the pre-starting crank angle Acr of the engine 12 at rest.

Another embodiment of this invention will be described. It is noted that the same reference signs as used in the first embodiment will be used to identify the same elements in the second embodiment, which will not be redundantly described.

### Second Embodiment

In the preceding first embodiment, the length of delay time tset1 is set on the basis of the engine speed Ne and the pre-starting crank angle Acr of the engine 12 upon which the rate of rise ΔNe of the engine speed Ne varies. In the present second embodiment, the rate of rise ΔNe of the engine speed Ne is directly calculated, and the calculated rate of rise ΔNe is used to set a length of delay time tset2.

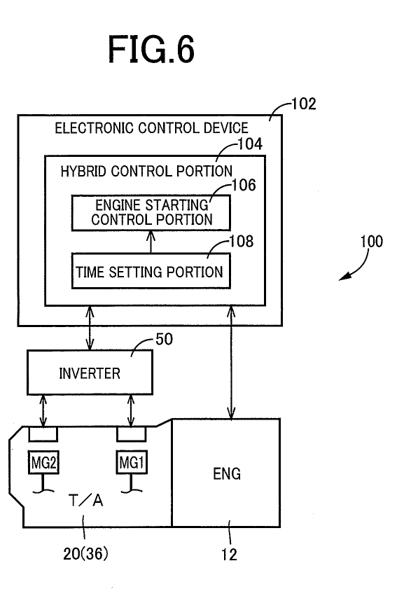

FIG. 6 is the functional block diagram showing major control portions of an electronic control device 102 according to the second embodiment of this invention for a hybrid vehicle 100. The electronic control device 102 according to this embodiment includes a hybrid control portion 104 including an engine starting control portion 106 and a time setting portion 108. Since the engine starting control portion 106 in this second embodiment is basically identical with the engine starting control portion 84 in the first embodiment, the description of the engine starting control portion 106 is omitted. It is noted that the engine starting control portion 106 corresponds to a control portion of the control apparatus according to the present invention.

The time setting portion 108 is configured to set the length of delay time tset2 on the basis of the operating speed Nex of the engine 12 at the moment of generation of the fuel injection command, and the rate of rise ΔNe of the engine speed Ne during a predetermined time period tf in the process of cranking of the engine 12, which time period tf starts from the moment of generation of the fuel injection command. (from the moment at which the fuel cut flag is turned off). The time setting portion 108 reads the engine speed Nex at the moment of generation of the fuel injection command. Further, the time setting portion 108 reads the engine speed Nea at a point of time ta which is the predetermined time period tf after the moment of generation of the fuel injection command, and then calculates the rate of rise ΔNe of the engine speed Ne by dividing a difference between the engine speeds Nea and Nex by the predetermined time period tf, that is, according to an equation (Nea−Nex)/tf. It is noted that the time setting portion 108 corresponds to a time setting portion of the control apparatus according to the present invention.

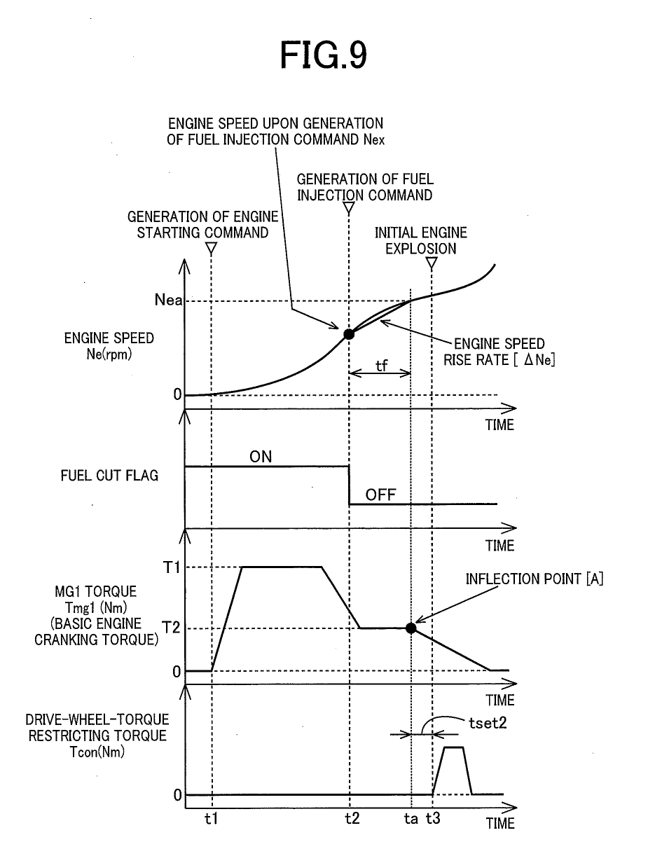

The predetermined time period tf is a period corresponding to a difference (ta−t2), namely, a period between the point of time ta of an inflection point A (indicated in FIG. 9 and described below) of the MG1 torque Tmg1, and a point of time t2 (indicated in FIG. 9) which is the moment of generation of the fuel injection command. The MG1 torque Tmg1 to crank the engine 12 is controlled according to a predetermined basic pattern of engine cranking value as indicated in FIG. 9. Namely, MG1 torque Tmg1 is initially raised to a first value T1, held at this first value T1 for a predetermined length of time, lowered to a second value T2 smaller than the first value T1, held at the second value T2 for a predetermined length of time, and is finally lowered toward zero. As indicated in FIG. 9, the basic pattern of engine cranking value of the MG1 torque Tmg1 has an inflection point A which is the point of time ta at which the length of time for which the MG1 torque Tmg1 is held at the value T2 is terminated, and at which the lowering of the MG1 torque Tmg1 toward zero is initiated. The basic pattern of engine cranking value of the MG1 torque Tmg1 is formulated so as to prevent the first explosion of the engine 12 prior to a moment of the inflection point A. The time setting portion 108 is configured to calculate the rate of rise ΔNe of the engine speed Ne on the basis of the engine speed Nex at the moment of generation of the fuel injection command, the engine speed Nea at the moment of the inflection point A, and the above-indicated predetermined time period tf (=ta−t2).

The time setting portion 108 stores therein a time setting map (a two-dimensional map, described below in detail) used for setting the length of delay time tset2 on the basis of the engine speed Nex and the rate of rise ΔNex of the engine speed Ne. The time setting portion 108 is configured to set the length of delay time tset2 according to the time setting map, and on the basis of the engine speed Nex at the moment of generation of the fuel injection command and the calculated rate of rise ΔNex of the engine speed Ne. The engine starting control portion 106 implements the engine starting control on the basis of the set length of delay time tset2. Described more specifically, the engine starting control portion 106 controls the first electric motor MG1 so as to generate the drive-wheel-torque restricting torque Tcon in addition to the MG1 torque Tmg1 to crank the engine 12, when the set length of delay time tset2 has passed after the point of time ta corresponding to the inflection point A at which the predetermined time period tf from the moment of generation of the fuel injection command has expired. The point of time ta corresponds to the predetermined point of time of the present invention.

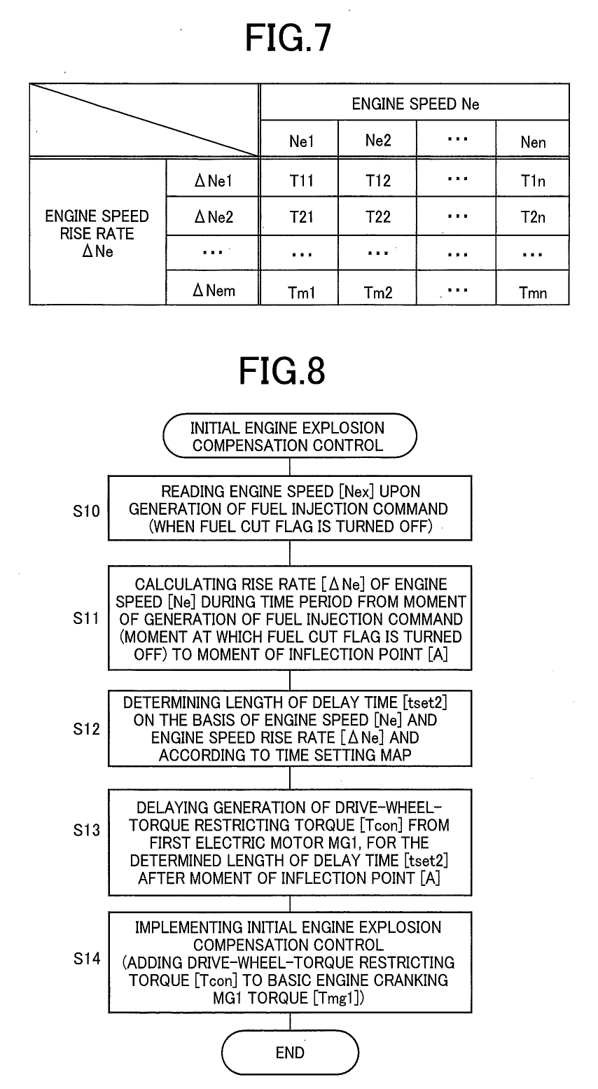

FIG. 7 is the table indicating an example of the time setting map (relation map, two-dimensional map) used by the electronic control device 102 of FIG. 6 to set the length of delay time (waiting time) tset2 from the point of time ta of the inflection point A to the moment of generation of the drive-wheel-torque restricting torque Tcon. This time setting map is obtained by experimentation or calculation. As shown in FIG. 7, the time setting map is defined in a two-dimensional coordinate system in which the engine speed Ne at the moment of generation of the fuel injection command and the rate of rise ΔNe of the engine speed Ne are taken in the respective two axes. Described more specifically, the time setting map is formulated such that the engine speed Ne is defined in a range between Ne1 and Nen in which the engine speed Ne is estimated to fall at the moment of generation of the fuel injection command to the engine 12, while the rate of rise ΔNe of the engine speed Ne is similarly defined in a range between ΔNe1 and ΔNem in which the rate of rise ΔNe is estimated to fall during cranking of the engine 12. The time setting portion 108 sets the length of delay time tset2 on the basis of an actual value Nex of the engine speed Ne and an actual value ΔNex of the rate of rise ΔNe of the engine speed Ne, and according to the time setting map. It is noted that the length of delay time tset2 need not be obtained according to the time setting map as shown in FIG. 7, but may be obtained on the basis of the actual value Nex of the engine speed Ne and the actual value ΔNex of the rate of rise ΔNe of the engine speed Ne, and according to a predetermined equation which includes, as variable, the engine speed Ne and the rate of rise ΔNe.

FIG. 8 is the flow chart illustrating a major control operation of the electronic control device 102 of FIG. 6, namely, an initial engine explosion compensation control routine executed to reduce the shock to be given to the vehicle 10 and the tooth butting noise due to the initial explosion of the engine 12 during the engine starting control (during cranking of the engine 12). This initial engine explosion compensation control routine is executed concurrently with the engine starting control initiated upon determination of requirement for starting the engine 12.

The control routine of FIG. 8 is initiated with a step S10 corresponding to the function of the time setting portion 108, to read the engine speed Nex at the moment of generation of the fuel injection command (that is, when the fuel cut flag is turned off). Then, the control flow goes to a step S11 also corresponding to the function of the time setting portion 108, to calculate the rate of rise ΔNex of the engine speed Ne during the time period tf from the moment of generation of the fuel injection command to the moment of the inflection point A of the MG1 torque Tmg1. The control flow then goes to a step S12 also corresponding to the function of the time setting portion 108, to set the length of delay time tset2 on the basis of the engine speed Nex read in the step S10 and the rate of rise ΔNex of the engine speed value Ne calculated in the step S11, and according to the time setting map shown in FIG. 7. Then, the control flow goes to a step S13 corresponding to the function of the engine starting control portion 106, to delay the generation of the drive-wheel-torque restricting torque Tcon from the first electric motor MG1, for the length of delay time tset2 set in the step S12, after the point of time ta corresponding to the inflection point A. The control flow then goes to a step S14 also corresponding to the function of the engine starting control portion 106, to implement the initial engine explosion compensation control when the length of delay time tset2 has passed after the point of time ta. In the initial engine explosion compensation control, the first electric motor MG1 is controlled to generate the sum Tsum of the MG1 torque Tmg1 to crank the engine 12 (which changes according to the basic pattern of engine cranking torque), and the drive-wheel-torque restricting torque Tcon.

FIG. 9 is the time chart indicating changes of various parameters during the engine starting control (i.e. during execution of cranking of the engine) while the initial engine explosion compensation control routine illustrated in the flow chart of FIG. 8 is executed to reduce the risk of generation of the shock to be given to the vehicle 10 and generation of the tooth butting noises of the gears due to the initial explosion of the engine 12.

Prior to a point of time t1, the fuel cut flag is held in the ON state so that a supply of a fuel to the engine 12 is cut, and the engine speed Ne is held at zero (the engine 12 is held at rest). At the point of time t1, a command to start the engine 12 is generated, and a rise of the torque Tmg1 of the first electric motor MG1 along the predetermined pattern of basic engine cranking torque is initiated, so that the engine speed Ne is raised.

At a point of time t2, the fuel injection command is generated, namely, the fuel cut flag is turned from the ON state to the OFF state. At a point of time ta corresponding to the inflection point A, the rate of rise ΔNex of the engine speed Ne during the predetermined time period tf between the point of time t2 and the point of time ta is calculated, and the length of delay time tset2 is set on the basis of the engine speed Nex and the calculated rate of rise ΔNex of the engine speed Nex. The generation of the drive-wheel-torque restricting torque Tcon is delayed for the set length of delay time tset2 from the point of time ta. At a point of time t3 at which the length of delay time tset2 has passed after the point of time ta, the first electric motor MG1 is controlled so as to generate the drive-wheel-torque restricting torque Tcon. Since the length of delay time tset2 is set on the basis of the engine speed Nex, and the calculated rate of rise ΔNex of the engine speed Nex, the drive-wheel-torque restricting torque Tcon is generated at the moment of the initial explosion of the engine 12, irrespective of the variation of the rate of rise ΔNe, so that the risk of generation of the shock to be given to the hybrid vehicle 100 due to the torque applied to the drive wheels 40 upon the initial explosion of the engine 12 can be effectively reduced. Further, the risk of generation of the tooth butting noises of the gears due to the torsional stress applied to the damper 18 can be effectively reduced.

As described above, the second embodiment is configured to set the length of delay time tset2 on the basis of the rate of rise ΔNe of the engine speed Ne during cranking of the engine 12, so that it is possible to accurately synchronize the moment of generation of the drive-wheel-torque restricting torque Tcon from the first electric motor MG1, with the moment of the initial explosion of the engine 12. Therefore, it is possible to reduce the torque to be applied to the drive wheels 40 upon the initial explosion of the engine 12, and it is accordingly possible to effectively reduce the shock to be given to the hybrid vehicle 100 during the engine starting control.

While the preferred embodiments of this invention have been described in detail by reference to the drawings, it is to be understood that the invention may be otherwise embodied.

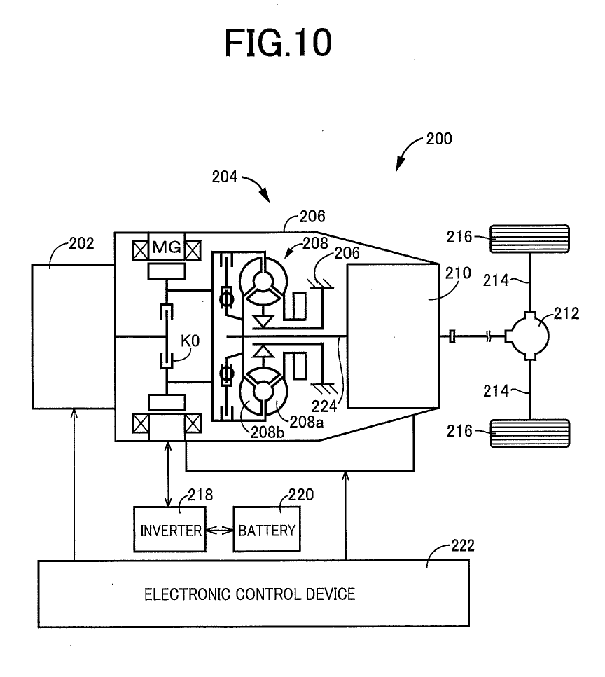

In the illustrated embodiments described above, the control apparatus is provided to control the hybrid vehicle 10, 100 provided with the first electric motor MG1, the power distributing mechanism 32 for distributing the drive force of the engine 12 to the first electric motor MG1 and the drive wheels 40, and the second electric motor MG2 operatively connected to the power distributing mechanism 32 through the gear mechanism 34. However, the control apparatus according to the invention may be used for any other type of hybrid vehicle, for instance, for a hybrid vehicle 200 shown in FIG. 10. The hybrid vehicle 200 is provided with a drive power source in the form of an engine 202 and an electric motor MG, and a power transmitting system 204. As shown in FIG. 10, the power transmitting system 204 includes a clutch K0, a torque converter 208 and a step-variable transmission portion 210, which are disposed within a stationary member in the form of a casing 206 fixed to a body of the hybrid vehicle 200, in the order of description as seen from the side of the engine 202. The power transmitting system 204 includes a differential gear device 212 and axles 214. The torque converter 208 has a pump impeller 208a connected to the engine 202 through a clutch K0 and connected directly to the electric motor MG, and a turbine impeller 208b connected directly to the step-variable transmission portion 210. In the power transmitting system 204, a drive force of the engine 202 and/or a drive force of the electric motor MG are/is transmitted to drive wheels 216 through the clutch K0 (where the drive force of the engine 202 is transmitted), the torque converter 208, the step-variable transmission portion 210, the differential gear device 212 and the axles 214. The step-variable transmission portion 210 is an automatic transmission which constitutes a part of a power transmitting path between the drive power source (engine 202 and electric motor MG) and the drive wheels 216, and which is shifted with engagement of at least one of a plurality coupling devices. The vehicle 200 is provided with an inverter 218, an electric power storage device in the form of a battery 220 to and from which an electric power is supplied through the inverter 218 from and to the electric motor MG, and a control apparatus in the form of an electronic control device 222.

When the engine 202 is required to start, the electronic control device 222 implements an engine starting control in which the clutch K0 is placed into its engaged state, the electric motor MG is controlled to generate an engine cranking torque Tmg to crank the engine 202 for raising the engine speed Ne, and the engine 202 is started with fuel injection therein and ignition after the predetermined length of time has passed and the engine speed Ne has been raised to a value at which the engine 202 can be operated by itself. The electronic control device 222 commands the electric motor MG to generate a drive-wheel-torque restricting torque Tcon for restricting a torque to be applied to the drive wheels 216 upon initial explosion of the engine 202, when a predetermined length of delay time tset has passed after the moment of generation of a fuel injection command. The electronic control device 222 for the vehicle 200 is also configured to set the length of delay time tset on the basis of the engine speed Ne, and the pre-starting crank angle Acr of the engine 202 at rest, or the rate of rise ΔNe of the engine speed Ne during cranking of the engine 202, so that the drive-wheel-torque restricting torque Tcon is generated at the moment of the initial explosion of the engine 202, whereby the shock to be given to the hybrid vehicle 200 due to the initial explosion of the engine 202 is effectively reduced. In essence, the principle of the present invention is applicable to any vehicle which provided with an engine serving as a drive power source and an electric motor an output torque of which is transmitted to drive wheels, and in which the output torque of the electric motor is adjustable. Although the vehicle 200 is provided with a fluid-operated type power transmitting device in the form of the torque converter 208, the torque converter 208 may be replaced by any other type of fluid-operated power transmitting device such as a fluid coupling, which does not have a torque boosting function. Further, the torque converter 208 need not be provided, or may be replaced by a simple clutch device.

In the illustrated first embodiment, the drive-wheel-torque restricting torque Tcon is generated by the first electric motor MG1 which generates the MG1 torque Tmg1 to crank the engine 12. However, the second electric motor MG2 may generate a drive-wheel-torque restricting torque Tcon′ to restrict the torque to be applied to the drive wheels 40 upon the initial explosion of the engine 12. Namely, the second electric motor MG2 may generate the drive-wheel-torque restricting torque Tcon′ to restrict the torque to be applied to the drive wheels 40 upon the initial explosion of the engine 12, when the predetermined length of delay time tset1 has passed after the moment of generation of the fuel injection command. In this case where the second electric motor MG2 generates the drive-wheel-torque restricting torque Tcon′, the shock to be given to the vehicle 10 upon the initial explosion of the engine 12 can be reduced. In essence, the control apparatus according to the present invention is applicable to any vehicle wherein an output torque of its electric motor to be transmitted to its drive wheels is adjustable. It is noted that where the vehicle 10 is provided with the second electric motor MG2 to generate the drive-wheel-torque restricting torque Tcon′, the torsional stress applied to the damper 18 is not reduced by the drive-wheel-torque restricting torque Tcon′, so that it is rather difficult to reduce the risk of generation of the tooth butting noises of the gears due to the torsional stress applied to the damper 18.

In the first embodiment, the time setting map to set the length of delay time tset1 shown in FIG. 3 is formulated such that the pre-starting crank angle Acr of the engine 12 is in the range from −180° to +180°. However, the length of delay time tset1 need not be set within the entire range of the crank angle Acr, but may be set within a limited range of the crank angle Acr, for instance, within a range from −90° to +90°.

In the illustrated second embodiment, the time setting portion 108 calculates the rate of rise ΔNex of the engine speed Nex, and sets the length of delay time tset2 on the basis of the engine speed Nex and the calculated rate of rise ΔNex of the engine speed Nex. However, the rate of rise ΔNe of the engine speed Ne may be replaced by the difference (=Nea−Nex) between the engine speed Nea at the moment of the inflection point A and the engine speed Nex at the moment of generation of the fuel injection command, provided the time period tf is constant.

In the second embodiment, the time setting portion 108 calculates the rate of rise ΔNex of the engine speed Nex during the time period tf from the moment of generation of the fuel injection command to the engine 12 to the moment of the inflection point A. However, the time period tf is not necessarily terminated at the moment of the inflection point A, but may be terminated at a point of time prior to the moment of the initial explosion of the engine 12.

In the second embodiment, the generation of the drive-wheel-torque restricting torque Tcon is delayed until the length of delay time tset2 passes after the predetermined time period tf from the moment of generation of the fuel injection command to the engine 12 to the moment of the inflection point A. However, the drive-wheel-torque restricting torque Tcon may be generated when the set length of delay time tset2 has passed after the moment of generation of the fuel injection command to the engine 12. In this respect, it is noted that the length of delay time tset2 may be changed as needed depending upon the point of time at which the length of delay time tset2 starts.

It is to be understood that the embodiments and modifications described above are given for illustrative purpose only, and that the present invention may be embodied with various other changes and improvements which may occur to those skilled in the art.

### NOMENCLATURE OF ELEMENTS

10, 100, 200: Hybrid vehicle (Vehicle)
12, 202: Engine
40, 216: Drive wheels
80, 102, 222: Electronic control device (Control apparatus)
84, 106: Engine starting control portion (Control portion)
86, 108: Time setting portion
MG1: First electric motor (Electric motor)
MG: Electric motor

What is claimed is:

1. A control apparatus for a vehicle provided with an engine, and an electric motor adjusting a torque to be transmitted to drive wheels, said control apparatus comprising:
a control portion configured to control the electric motor so as to generate a drive-wheel-torque restricting torque for restricting a torque to be applied to the drive wheels upon initial explosion of the engine as a result of cranking of the engine to start the engine, when a predetermined length of delay time has passed after a predetermined point of time prior to a moment of the initial explosion of the engine; and
a time setting portion configured to set the predetermined length of delay time on the basis of an operating speed of the engine during cranking of the engine, and one of a pre-starting crank angle of the engine at rest and a rate of rise of the operating speed of the engine during its cranking.

2. The control apparatus according to claim 1, wherein said predetermined point of time is a moment of generation of a control command to initiate fuel injection into the engine, and the time setting portion sets the length of delay time on the basis of the operating speed of the engine at the moment of generation of said control command and the pre-starting crank angle of the engine at rest.

3. The control apparatus according to claim 1, wherein said predetermined point of time is a moment of generation of a control command to initiate fuel injection into the engine, or a point of time at which a predetermined time has passed after the moment of generation of said control command, and the time setting portion sets the length of delay time on the basis of the operating speed of the engine at the moment of generation of said control command, and the rate of rise of the operating speed of the engine during a time period in the process of cranking of the engine, the time period starting from the moment of generation of the control command and having a length of the predetermined time.
